(19) United States
(12) Patent Application Publication
(10) Pub. No.: US 2012/0047223 A1
(43) Pub. Date: Feb. 23, 2012

(54) METHOD AND APPARATUS FOR DISTRIBUTED STORAGE

(75) Inventor: Sasu Tarkoma, Helsinki (FI)

(73) Assignee: Nokia Corporation, Espoo (FI)

(21) Appl. No.: 12/860,539

(22) Filed: Aug. 20, 2010

(51) Int. Cl. G06F 15/16

(52) U.S. Cl. 709/217

(57) ABSTRACT

An approach is provided for a distributed storage system. A device determines to publish a request for content, the request based, at least in part, on one or more criteria. One or more responses are received from one or more storage blocks that have one or more subscriptions to at least one of the one or more criteria. Another request, to transfer the content to at least one destination subscription is published based, at least in part, on the one or more responses.

### BACKGROUND

Service providers and device manufacturers (e.g., wireless, cellular, etc.) are continually challenged to deliver value and convenience to consumers by, for example, providing compelling network services. Important differentiators in the industry are application and network services as well as capabilities to support and scale these services. In particular, these applications and services can include accessing and managing data utilized by one or more applications and/or services. However, supporting a larger base of users attempting to access and/or manage a growing amount of data can be technically challenging. For example, challenges can exist in determining storage locations and minimizing costs of the storage locations. Further, the increase in use of storage mechanisms for storing data increases the need for an advantageous approach to distributed data storage.

### SOME EXAMPLE EMBODIMENTS

Therefore, there is a need for an approach for implementing a storage system utilizing publication and subscription interfaces.

According to one embodiment, a method comprises determining to publish a request for content, the request based, at least in part, on one or more criteria. The method also comprises receiving one or more responses from one or more storage blocks that have one or more subscriptions to at least one of the one or more criteria. The method further comprises determining to publish another request to transfer the content to at least one destination subscription based, at least in part, on the one or more responses.

According to another embodiment, an apparatus comprises at least one processor, and at least one memory including computer program code, the at least one memory and the computer program code configured to, with the at least one processor, cause, at least in part, the apparatus to determine to publish a request for content, the request based, at least in part, on one or more criteria. The apparatus is also caused to receive one or more responses from one or more storage blocks that have one or more subscriptions to at least one of the one or more criteria. The apparatus is further caused to determine to publish another request to transfer the content to at least one destination subscription based, at least in part, on the one or more responses.

According to another embodiment, a computer-readable storage medium carries one or more sequences of one or more instructions which, when executed by one or more processors, cause, at least in part, an apparatus to determine to publish a request for content, the request based, at least in part, on one or more criteria. The apparatus is also caused to receive one or more responses from one or more storage blocks that have one or more subscriptions to at least one of the one or more criteria. The apparatus is further caused to determine to publish another request to transfer the content to at least one destination subscription based, at least in part, on the one or more responses.

According to another embodiment, an apparatus comprises means for determining to publish a request for content, the request based, at least in part, on one or more criteria. The apparatus also comprises means for receiving one or more responses from one or more storage blocks that have one or more subscriptions to at least one of the one or more criteria. The apparatus further comprises means for determining to publish another request to transfer the content to at least one destination subscription based, at least in part, on the one or more responses.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of distributed storage, according to one embodiment;

FIG. 2 is a diagram of the components of a server that can be utilized in implementing a service and/or storage block, according to one embodiment;

FIG. 3 is a flowchart of a process for retrieving content based on a publication and subscription model, according to one embodiment;

FIGS. 4 and 5 are flow diagram of processes for causing a storage block to publish content to a destination subscription, according to various embodiments;

FIG. 6 is a flow diagram of a process for replicating content using a publication and subscription model, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for providing a storage system utilizing publication and subscription interfaces are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

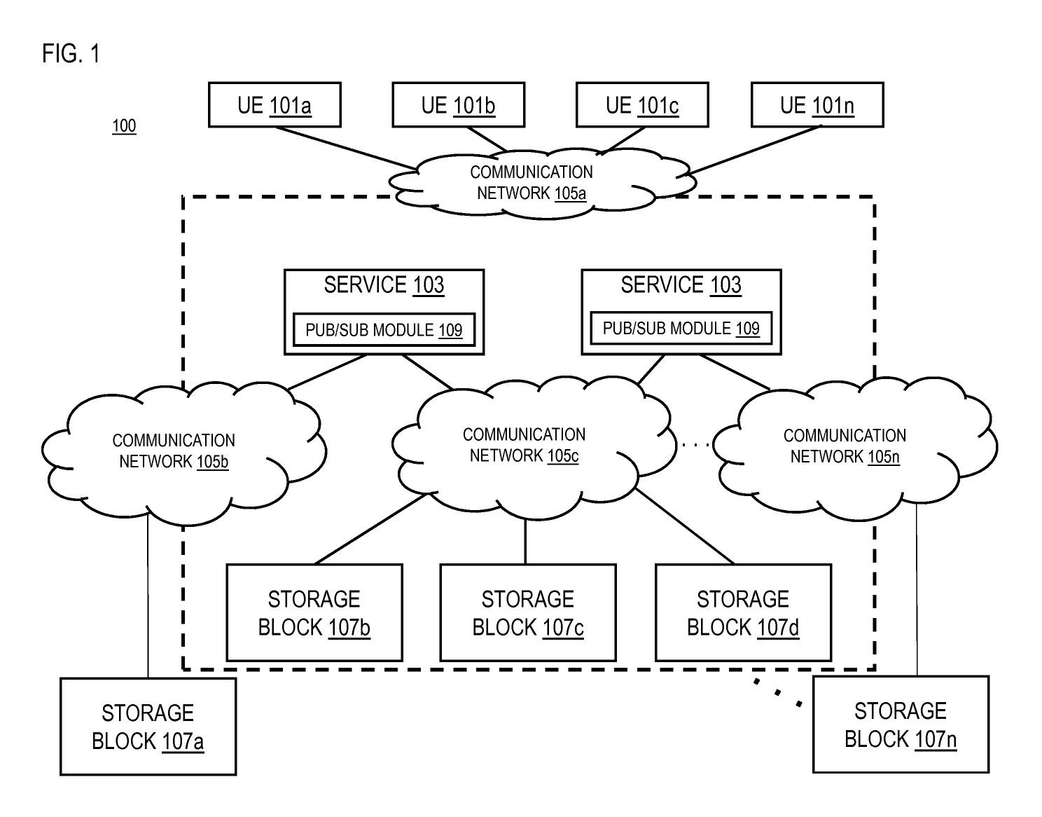

FIG. 1 is a diagram of a system capable of distributed storage, according to one embodiment. Distributed storage organization allows for the storage of content at one or more locations. As such, storage can be virtualized (e.g., pertain to the abstraction of local storage from physical storage). The cost of such cloud-based storage is expected to be a portion of operating costs for internet-based services. Thus, it can be advantageous to reduce the operating costs for distributed storage systems while still maintaining a quick, efficient, and available storage system.

One approach to reduce the costs of a storage system is to consolidate servers and storage to reduce infrastructure investments and decrease storage and/or server management costs or centrally manage a server and storage resources to reduce administrative costs. Another approach is to reduce network congestion by removing data traffic (e.g., filtering of a network). Further, a service provider can enhance application performance and reduce backup times by offloading backup and/or other data movement from application networks. Moreover, servers and storage can be independently scaled to increase flexibility. To achieve greater availability of content, the service provider can introduce path, server, and storage failover.

Storage solutions can be based on one or more different types of techniques (e.g., block-based storage, distributed hash tables, linear hashing techniques, multi-tiered storage, resource pooling, etc.). In one example, in a block-based storage environment, a single block of information can be accessed using a logical unit identifier (LUN) and an offset within that LUN (e.g., a Logical Block Address (LBA)). Address mapping can be between a logical disk, e.g., a virtual disk, and a logical unit represented by one or more storage controllers. The LUN may also be a product of a virtualization in a different layer.

In another example, a tiered storage can store information in a database in such a way that information searched for more often is moved to a different tier, producing faster search results. When available storage capacity is pooled, system administrators no longer need to search for disks that have free space to allocate to a particular host or server. A new logical disk can be simply allocated from an available pool of resources, or an existing disk can be expanded.

In data-centric storage, a hash-like interface can be utilized where data (or data structures) can be stored and retrieved by an identifier (e.g., a name). This can be achieved by deterministically mapping (e.g., hashing) a data name to a geographic location within a network. Further, other storage systems, such as peer-to-peer storage systems (e.g., Cooperative File System (CFS)), linear hashing, and clustering can be utilized for data-centric storage. However, there is inadequate support for an easy and flexible data and content centric storage with fine-grained search, security, and management operation.

To address this problem, a system 100 of FIG. 1 introduces the capability to provide content storage based on a publish and subscription mechanism. Such a publish and subscription mechanism can be utilized to develop an Application Programming Interface (API) to reduce the cost of storage systems. The API can abstract the internal structure and distribution of a storage solution while providing fine-grained policy and content management features. As such, storage network interfaces can be defined in terms of publish operations, subscribe operations, and actual content. This can provide a full decoupling of functions and separation of concerns. In one embodiment, only data labels or content descriptions matter in a lookup for content. Further the data labels or content descriptions can meet one or more specified non-functional requirements.

User equipment (UEs) 101a-101n can be utilized to access one or more services 103 (e.g., a messaging service, a social networking service, an information service, a web site, other network services, etc.) via a communication network 105a. In certain embodiments, the communication network 105a can be connected to other communication networks (e.g., communication networks 105b-105n). In other embodiments one or more of the communication networks 105 can be independent. As such, services 103 can also be connected to other services 103, UEs 101, storage blocks 107, etc. via one or more communication network 105. As used herein, the term storage block 107 refers to a device that can be utilized for storing information. Although various embodiments are described with respect to storage blocks 107 being associated with one or more servers with storage capabilities, it is contemplated that the approach described herein may be used with other devices. Further, it is noted that various embodiments are described with respect to services 103, however it is contemplated that one or more of the functions of the service 103 can be performed by other devices or clients (e.g., UEs 101). Further, in certain embodiments, a communication network (e.g., communication network 105c) can be a high throughput network (e.g., a storage area network, a fibre channel network, a gigabit Ethernet network, etc.). In other embodiments a communication network 105 can include other communication technologies (e.g., utilization of the internet). As such, the storage blocks 107 can be located in different networks across the world.

In one embodiment, the UEs 101 can utilize a service 103 using an API. The service 103 can accept UE 101 requests and interface with the storage blocks 107 in a storage substrate via a publication/subscription (pub/sub) interface. In certain embodiments, the pub/sub is a messaging paradigm where publishers (senders) of messages send their messages based on one or more criteria. Published messages can be characterized into classes. These classes can be categorized without any knowledge of who the subscribers (if any) are. Subscribers express interest in one or more classes (e.g., by subscribing to the classes). As such, subscribers may only receive messages that are pertinent. Further, the subscribers may also have no knowledge of who the publishers are. As such, publishers and subscribers can be decoupled. With this approach, greater scalability can be achieved along with a more dynamic network topology. The service 103 can include a pub/sub module 109 that can utilize pub/sub primitives (e.g., simple elements associated with a pub/sub mechanism) to communicate with one or more of the storage blocks 107. The storage blocks 107 may additionally include a pub/sub interface. Each storage block 107 can inform the services 103 (and associated control elements such as the pub/sub module 109) of the structure and/or availability of the storage block 107. The pub/sub module 109 can have built-in server selection and data indexing. The index can be part of the pub/sub communications plane.

The storage block 107 can have a number of subblocks that each has a content descriptor (e.g., a hash or other metadata) and actual binary content associated with the descriptor. Each block or subblock may expose one or more interfaces. The blocks can include an interface for a data/content block address range that is subscribed. This allows any interested entity to publish a message that pertains to the content in the block to the block. As such, the block address range is subscribed to the data/content block address range and/or other criteria describing the content associated with the block address range. In another embodiment, the blocks include a content request type subscription that allows an entity or any entity to specifically target a content request to the storage block 107. In certain scenarios, a Bloom filter subscription created using subblock identifiers that summarize content available on the block can be included as an interface. A Bloom filter is a space-efficient probabilistic data structure that is utilized to test whether an element is a member of a set. As such, one or more other methods of determining whether an element is a member of a set (e.g., of summarized content) is can be utilized to determine the subscription.

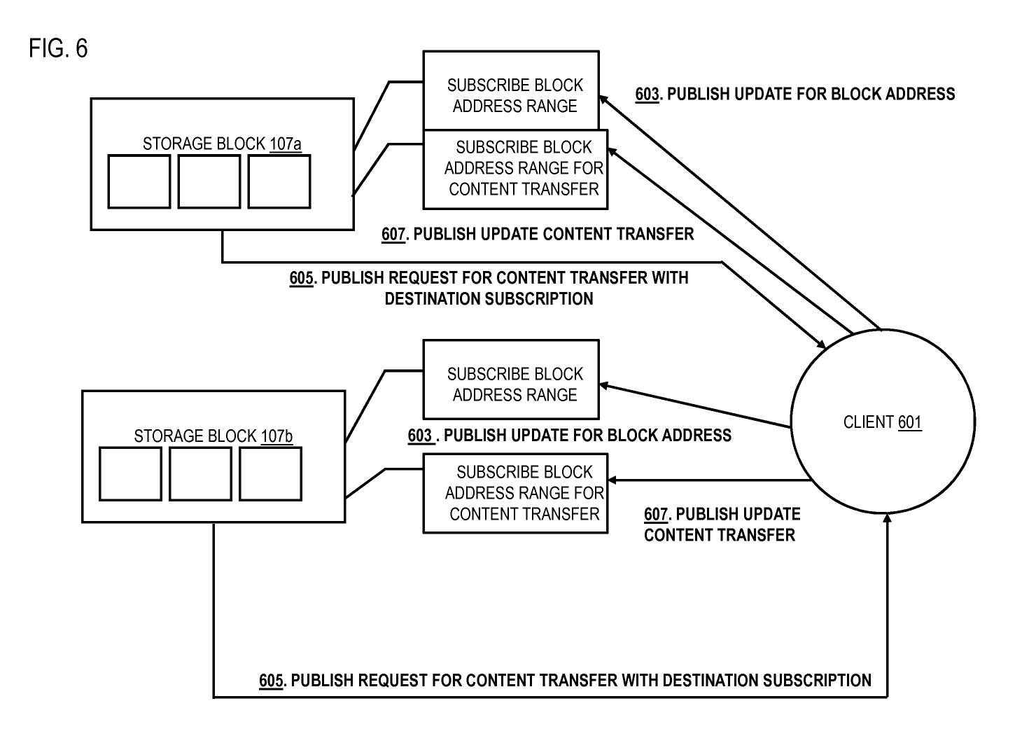

When a service 103 wishes to write to a storage block 107, the service 103 can publish a request to write to the block (e.g., via the block address range). In certain scenarios, the publication can be for a specific address range and/or version of the content. For example, a storage block may utilize one or more versions of the content, which may be separated using a content descriptor. As such, multiple versions of the content can be implemented and stored using the system 100. The system thus allows fine-grained access to the various versions and their replication. Thus, old versions of data or content can be moved to a permanent storage (e.g., a slow storage) if they are not accessed frequently. Version updating and replication is further detailed in FIG. 6.

When a service 103 wishes to access content from storage block 107, the service 103 can publish a request for a certain content address on a channel. The storage blocks 107 that have a subscription to the content address will receive the request. Each storage block 107 listening can then publish a response to the request to the service 103 indicating the availability of the content. Availability can include the load of the storage block 107, quality of service information, version information of the content, etc. In certain embodiments, the service 103 can be listening on a specified channel associated with the request, block, address, or a combination thereof. The service 103 receives the responses and formulates a content request for the actual content to the correct block (e.g., based on the response). The content request can include a subscription to publish the content to. The storage block 107 can then begin transfer of the content to the service 103 by publishing the content to the specified subscription. The service 103 and/or other services 103 or devices subscribed to the specified subscription can then receive the content.

In certain embodiments, a user (e.g., end-user, administrator, manager, etc.) of the UE 101 or of the service may utilize a user interface component to manage storage activities. Such a user interface can be implemented using content-based resource retrieval. For example, the user can specify content descriptors and/or meta-data, such as title names, author names, etc. rather than conventional file names. As a result, the user interface is more intuitive and can be easier to understand by enabling retrieval based on content meta-data.

As shown in FIG. 1, the system 100 comprises a user equipment (UE) 101 having connectivity to a service 103 and/or storage blocks 107 via one or more communication networks 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, services 103, storage blocks, etc. communicate with each other and other components of the communication networks 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, service 103 may interact according to a client-server model with the UEs 101. According to the client-server model, a client process sends a message including a request to a server process, and the server process responds by providing a service (e.g., social networking, augmented reality, messaging, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. Further, the service 103 can be considered a client of one or more storage blocks 107.

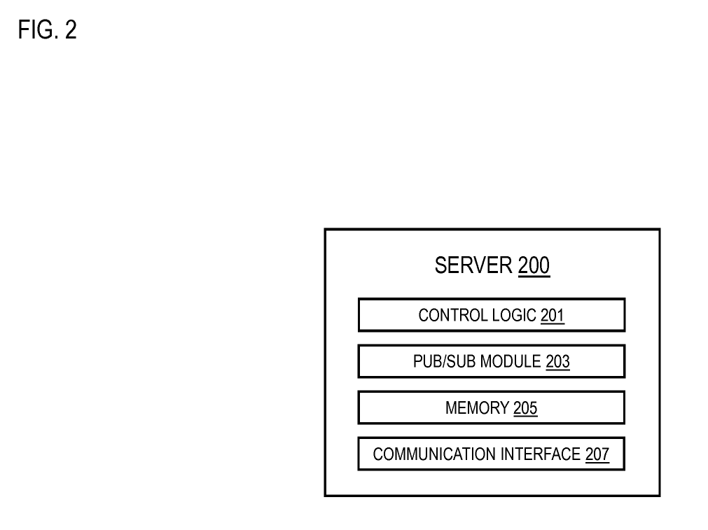

FIG. 2 is a diagram of the components of a server that can be utilized in implementing a service and/or storage block, according to one embodiment, according to one embodiment. By way of example, the server 200 includes one or more components for storing and retrieving content via a pub/sub interface. It is contemplated that the functions of these components may be combined in one or more components or performed by other components of equivalent functionality. In this embodiment, the server includes control logic 201 to control processing, a pub/sub module 203 to control publication and subscription processes, a memory 205, and a communication interface 207 to communicate with other devices.

Control logic 201 of the server 200 can be utilized to control one or more processes of the server 200. The control logic 201 can further be utilized to provide a service 103 as well as provide control to utilize storage blocks 107. For example, in a service 103, the control logic 201 can execute code stored in memory 205 to provide the service 103. Moreover, the control logic 201 can utilize a pub/sub module 203 to communicate via a storage substrate. The control logic 201 can be implemented on a block/disk resource level to support the content centric pub/sub storage.

Further, the system 100 can be implemented on different layers of a protocol stack. For example, it can be implemented as an overlay network utilizing one or more servers 200 that are Internet Protocol (IP) based. Pub/sub traffic can then be routed across the servers. The implementation can combine software and hardware features by partly replacing the internet protocol and, in place of or in addition to the internet protocol, using an Ethernet, another form of link layer addressing, etc.

In one embodiment, the communication interface 207 can be used to communicate via the storage substrate. Moreover, the communication interface 207 or another communication interface 207 of the server 200 can be utilized to communicate with one or more UEs 101 or other devices. Certain communications can be via methods such as an internet protocol, messaging (e.g., Short Message Service (SMS), Multimedia Messaging Service (MMS), etc.), or any other communication method (e.g., via the communication networks 105).

As noted above, the pub/sub module 203 can be utilized to send and receive messages via publications and subscriptions. The control logic 201 can subscribe the server 200 to one or more channels via the pub/sub module 203 to listen for relevant messages. Further, the control logic 201 can publish information it wishes to communicate via the pub/sub module 203 to other services 103, storage blocks 107, servers 200, a combination thereof, etc.

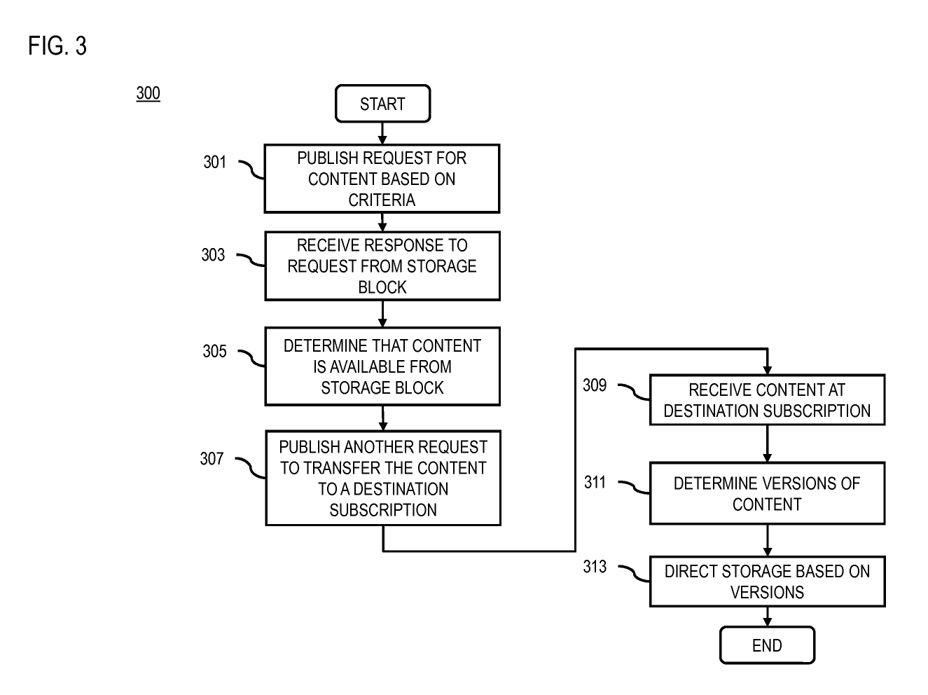

In one scenario, a service 103 is implemented via a server 200. As such, the service can execute via the control logic 201 and memory 205. Further, the communication interface 207 can be utilized to communicate with one or more UEs 101 (e.g., via an API). When the service 103 requires information stored on one or more storage blocks 107, the control logic 201 can utilize the pub/sub module 203 to retrieve content as further detailed in FIGS. 3, 4, and 5. The pub/sub module 203 of the service 103 can include logic to control access and information associated with storage blocks 107. For example, the memory 205 of can include a pub/sub routing table that provides a mapping table associated with the storage blocks 107.

In another scenario, a storage block 107 can be implemented via a server 200. A memory 205 of the storage block 107 can store content that can be retrieved by one or more services 103, clients, etc. The content can be stored in a volatile memory and/or a non-volatile memory. Further, the content may be stored in a database separate from a server 200 associated with the storage block 107.

As previously noted, the storage block 107 can provide an interface for accessing content via a block address range subscription, a content request type subscription, a Bloom filter subscription, or a combination thereof. In certain scenarios, the block address range subscription can refer to one or more address ranges for content for which the storage block 107 is subscribed. Further, the content request type subscription can include a content descriptor associated with the content (e.g., in metadata associated with the content). For example, a piece of content associated with a particular person in a social networking environment can include metadata specifying the person (e.g., a name of the person, a unique identifier to the person such as an e-mail account, etc.). In another example, a piece of content associated with an encyclopedia can be organized via one or more categories of content types (e.g., a historical time period, a name, a genus, a species, etc.). The Bloom filter subscription can be utilized to determine whether a content type stored in a storage block 107 is part of a content type that a service 103 is looking for. In certain embodiments, a hash or other lookup method can be utilized to perform the determination. Content metadata can be implemented via one or more different technologies, such as extensible markup language (XML), Resource Description Framework (RDF) graphs, etc. The storage block 107 can announce its availability by publishing its status via a control channel, which can be monitored by services 103.

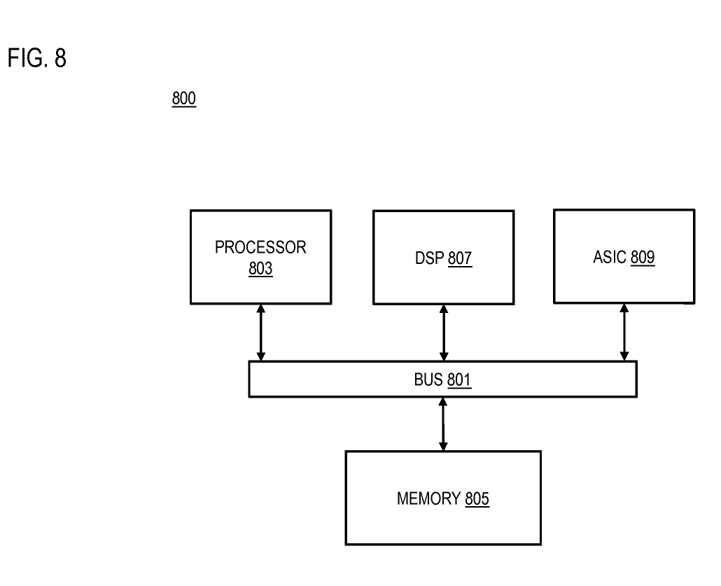

FIG. 3 is a flowchart of a process for retrieving content based on a publication and subscription model, according to one embodiment. In one embodiment, the control logic 201 of a service 103 performs the process 300 and is implemented in, for instance, a chip set including a processor and a memory as shown in FIG. 8. As such, the control logic 201 can provide means for accomplishing various parts of the process 300 as well as means for accomplishing other processes in conjunction with other components of a server 200 or other device.

A service 103 can receive a request for services from a UE 101. The service 103 may determine that the service 103 requires information from a storage block 107 to provide the service 103. As such, the control logic 201 can determine to publish a request for the content, the request based, at least in part, on one or more criteria (step 301). The criteria can be based, at least in part, on an address range associated with the content, a content request type (e.g., metadata), a probabilistic analysis, a combination thereof, etc. Moreover, the request can be based on a routing table stored in a memory 205 associated with the service 103. For example, the service 103 can narrow down which channels to publish the request to based on the routing table.

The control logic 201 can then receive one or more responses from one or more storage blocks that have one or more subscriptions to the channels the request was published on based on the one or more criteria (step 303). The one or more responses can include information regarding structure, availability, a combination thereof, etc. of the storage block. Availability can include a determination of whether the service 103, UE 101, or a particular user of the service 103 has access to the content, an availability of resources based on storage block load, a determination of whether the storage block 107 has access to the content, or a combination thereof. Further, the responses can include one or more quality of service parameters. Moreover, one or more quality of service parameters can be sent via the request, wherein the availability is based on whether the storage block meets the quality of service parameters. Example quality of service parameters include bandwidth available, local lookup time, storage block load, etc.

Then, at step 305, the control logic 201 can determine that the content is available from one of the storage blocks 107. This can be based on the response received from the one or more storage blocks 107. The received response can additionally include Meta-data that can be utilized to determine that the content is available. The control logic 201 can then be utilized to generate a request for a content transfer for the content from a particular storage block or a set of storage blocks that include the content. Then, the control logic 201 can cause publication of another request to transfer the content to at least one destination subscription (e.g., a subscription that the service 103 monitors) based, at least in part, on the one or more responses (step 307). As noted above, the other request can be based on the availability information associated with the storage blocks.

At step 309, the control logic 201 receives the content at the destination subscription(s). In certain embodiments, the control logic 201 may not monitor the subscription and another service 103 and/or UE 101 monitors the destination subscription for the information. Further, the content can be unicast on a channel or multicast on one or more channels from at least one of the storage blocks 107 that responded. In other embodiments, the content can be transferred using another protocol.

The service 103 may additionally modify the content and/or add additional content (e.g., by updating a document associated with the content). As such, the control logic 201 can determine a version associated with the content (step 311). Further, when publishing a request for content, a version of the content can be utilized in retrieving desired content. The version can be incremented when modified content is stored in the storage blocks 107 as further described in FIG. 6. Moreover, storage based on versions can be directed by the control logic 201 (step 313). For example, a frequency of access to the versions of the content can be determined. Based on the frequency or other criteria, the control logic 201 can determine to archive one or more of the versions. In one example, old or less utilized versions can be stored on a slower or more permanent (e.g., less volatile) storage block 107 while newer or more frequently used versions are stored on faster storage blocks 107 and/or caches.

In certain embodiments, the service can receive the content from caches as well as the storage blocks 107. Cache can be discovered by publishing a message using metadata that is subscribed to by the cache. The cache can respond in the in the same way as the storage blocks 107. As such, in certain embodiments, the cache can be considered a storage block 107. In certain scenarios, the cache can be local to hardware associated with the service 103, execute faster (e.g., in volatile memory), have greater bandwidth (e.g., based on a network type), etc. The cache can be populated as one or more services 103 retrieve content.

Moreover, in certain embodiments, the content from one storage block 107 can be split to another storage block 107 to balance utilization. This can allow part of an overloaded storage block 107 to be moved to a new storage block 107. When an overload or potential overload (e.g., based on a predetermined load threshold) is determined, the overloaded and new storage block can reallocate the address spaces covered by each respective storage block. The old and new storage blocks can then announce their respective address spaces via one or more control channels to services 103 and/or other pub/sub controllers. The announcement may additionally include publication of their status, control channels to which they subscribe, etc. In certain examples, the split can be based on reasons other than overload (e.g., rebalancing based on the introduction of one or more new storage blocks 107).

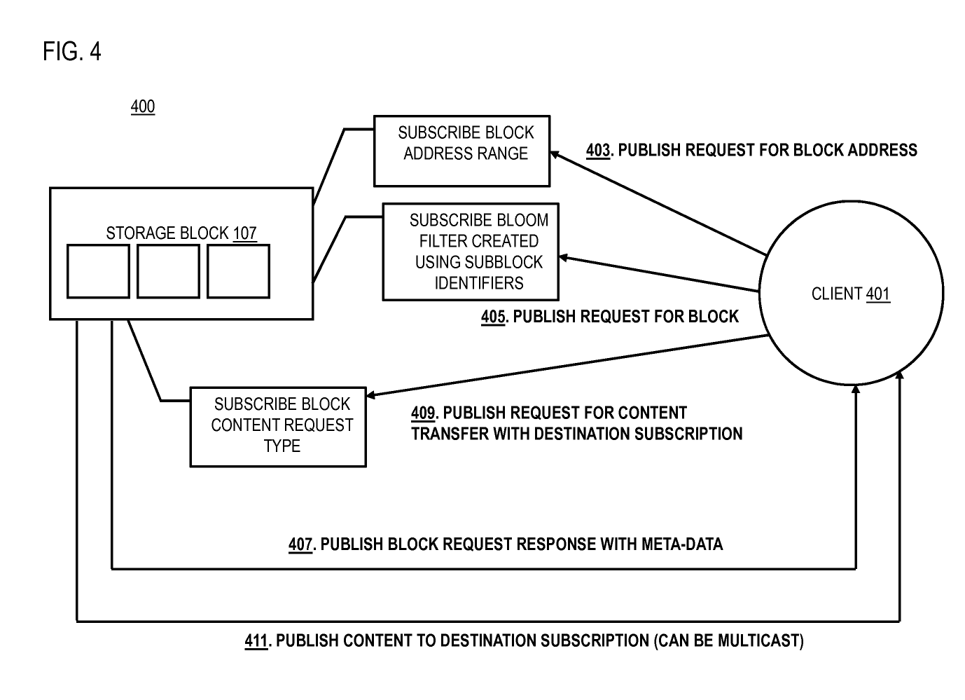

FIG. 4 is a flow diagram of a process for causing a storage block to publish content to a destination subscription, according to one embodiment. In one embodiment, the control logic 201 of a client 401 and/or storage block 107 performs the process 400 and is implemented in, for instance, a chip set including a processor and a memory as shown in FIG. 8. As such, the control logic 201 can provide means for accomplishing various parts of the process 400 as well as means for accomplishing other processes in conjunction with other components of a server 200 or other device.

The client 401 can be any device that utilizes a storage system including one or more storage blocks 107. For example, the client 401 can be a service 103, a UE 101, other computing devices, etc. Both the client 401 and storage block 107 may be implemented, at least in part, on a device such as a server 200.

At steps 403 and 405, the client 401 can publish a request for a block. The request can include a block address or a range of block addresses (e.g., as in step 403) or a request based on a subblock identifier associated with a filter (e.g., a Bloom filter). By way of example, content centric block addresses can be associated with or represented by names, flat labels (e.g., hashes), probabilistic set representations (e.g., Bloom filters), etc. A storage block 107 subscribed to the control channels associated with the publication can receive the request.

The storage block 107 then determines what content associated with the request is available on the storage block 107. The storage block 107 formulates a request response message indicating availability of the content and publishes the request response message (step 407). The response request can include Meta-data that includes one or more content types associated with the address range that the storage block 107 includes.

The client 401 receives the block request response and determines a specific content request based on one or more content request types provided in the request response. Then, the client 401 can choose the proper block based on the content type descriptor to request. A request for content transfer based on the content type descriptor is then published (step 409). The request can include a destination subscription to publish the content to. In response to the request, the storage block 107 can determine which content is associated with the content type request and publish the content to the destination subscription. The destination subscription may be multicast to more than one locations (e.g., to the client 401, more than one client, etc.). Multicasting can be via a single data channel subscribed to by multiple clients 401, multiple data channels, or combinations thereof.

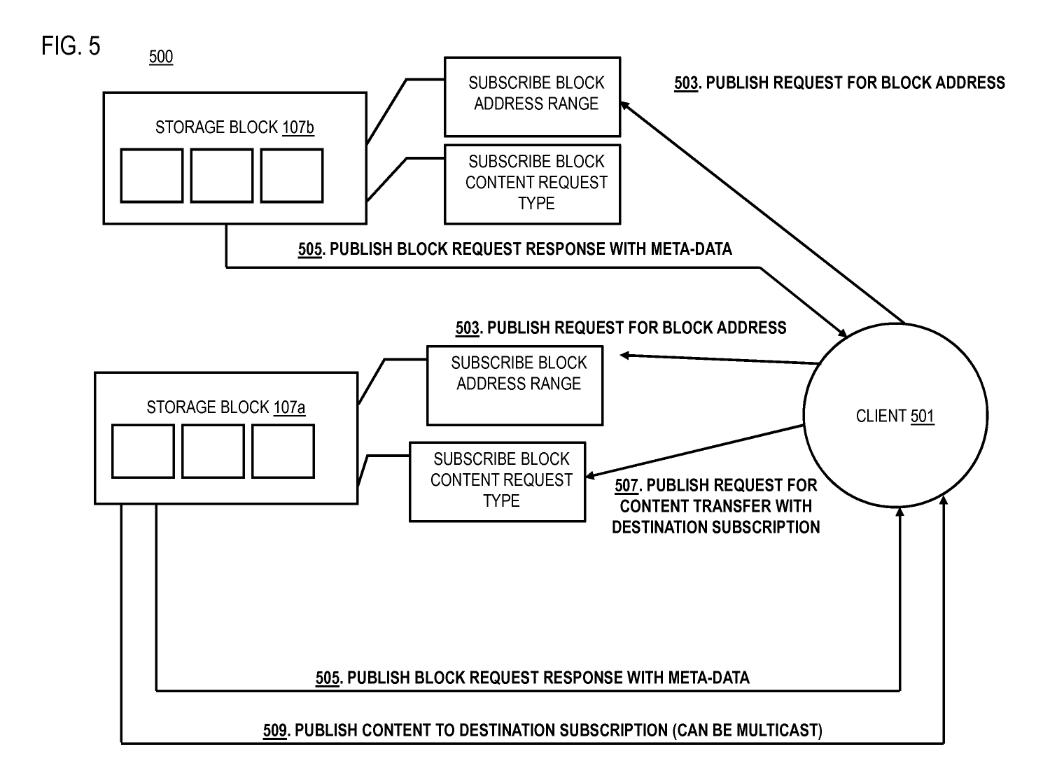

FIG. 5 is a flow diagram of a process for causing a storage block to publish content to a destination subscription, according to one embodiment. In one embodiment, the control logic 201 of a client 501 and/or storage block 107 performs the process 500 and is implemented in, for instance, a chip set including a processor and a memory as shown in FIG. 8. As such, the control logic 201 can provide means for accomplishing various parts of the process 500 as well as means for accomplishing other processes in conjunction with other components of a server 200 or other device. As noted previously, client 401 can be any device that utilizes a storage system including one or more storage blocks 107.

At step 503, the client 501 can publish a request for a block via a block address. The request can include a block address or a range of block addresses. Storage blocks 107a, 107b subscribed to the control channels associated with the publication can receive the request. As such, the storage blocks 107a, 107b may have overlapping address ranges to which they subscribe and/or store content for.

The storage blocks 107a, 107b then determine what content associated with the request is available on the respective storage blocks 107a, 107b. The storage blocks 107a, 107b formulate a request response message indicating availability of the content and publish the request response message (step 505). The response request can include Meta-data that includes one or more content types associated with the address range that the respective storage blocks 107a, 107b include. In certain embodiments, more than one of the storage blocks 107 respond, in other scenarios zero or one storage blocks respond (e.g., because the requested content is not included in the storage block 107).

The client 501 receives the block request response(s) and determines a specific content request based on one or more content request types provided in the request response. Both responses may be published on the same channel that the client 501 subscribes to. Then, the client 501 can choose the proper block based on the content type descriptor to request. In this scenario, the client 501 chooses storage block 107a. A request for content transfer based on the content type descriptor is then published (step 507) to the storage block 107a.

As noted previously, the request can include a destination subscription to publish the content to. In response to the request, the storage block 107a can determine which content is associated with the content type request and publish the content to the destination subscription. This embodiment shows one example of how two storage blocks 107 with a subscription to the same block address range can be utilized in harmony. More than two storage blocks 107 can be utilized in this manner.

FIG. 6 is a flow diagram of a process for replicating content using a publication and subscription model, according to one embodiment. In this embodiment, the client 601 can be utilized to update content at one or more storage blocks 107a, 107b. The client 601 can determine to store a piece of content. The content can be an updated version of a piece of content stored on a storage block 107 or the content can be new content. The client 601 can determine a subscription block address range associated with the content based on one or more descriptors associated with the content. The client 601 then publishes a notification of an update for the block address or block address range on a control channel associated with the address range (step 603). Storage blocks 107 that subscribe to the address range receive the notification. The storage blocks 107 can then determine to request a content transfer for the update. At step 605, the respective storage blocks 107a, 107b can publish a request for content transfer to a channel associated with the client 601. In certain embodiments, the associated channel is a parameter passed in the update notification. Further, the request for content transfer may additionally include a destination subscription for the client 601 to transfer the update data. The client 601 executes the request by publishing the update content with the specified address or address range specified (step 607). The specified content can be published to a single channel for all storage blocks 107 or separate data channels for each requested update.

With the above approaches, storage can efficiently be data and content centric. As such, indexing can be implicit based on the manner that content is stored and discovered (e.g., by finding a specific subblock to transfer content separately from transferring the content). Moreover, because of the content centric nature of the system, fine-grained content-aware management operations can be implemented. Further, because the content descriptor is decoupled from the actual content, the system is more apt to dynamic configurations.

The processes described herein for providing a storage system utilizing publication and subscription interfaces may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

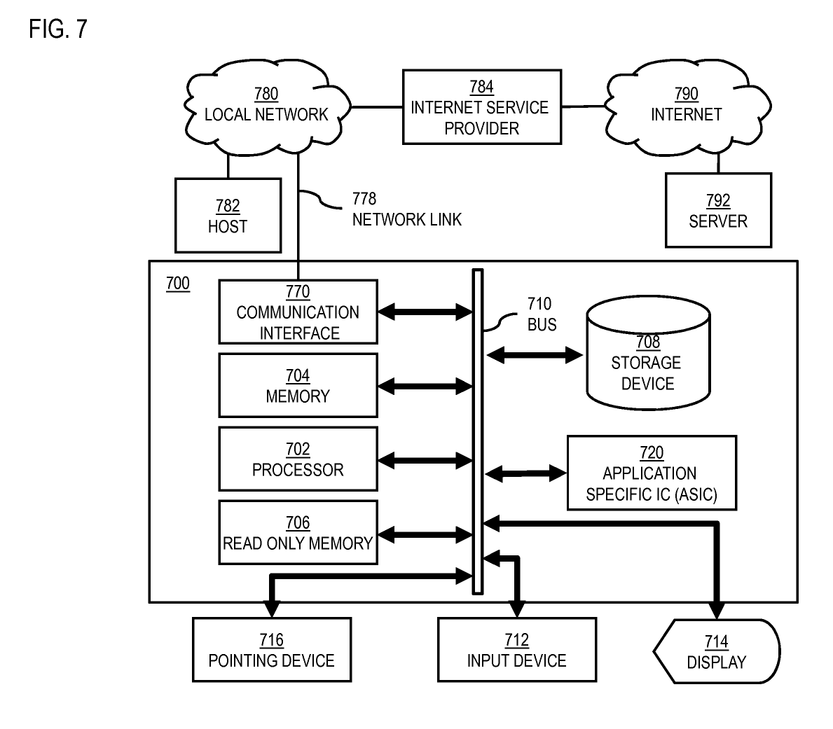

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide a storage system utilizing publication and subscription interfaces as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of providing a storage system utilizing publication and subscription interfaces.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to providing a storage system utilizing publication and subscription interfaces. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for providing a storage system utilizing publication and subscription interfaces. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing a storage system utilizing publication and subscription interfaces, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for UE 101, server 200, service 103, storage block 107, or a combination thereof.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to provide a storage system utilizing publication and subscription interfaces as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of providing a storage system utilizing publication and subscription interfaces.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide a storage system utilizing publication and subscription interfaces. The memory 805 also stores the data associated with or generated by the execution of the inventive steps.

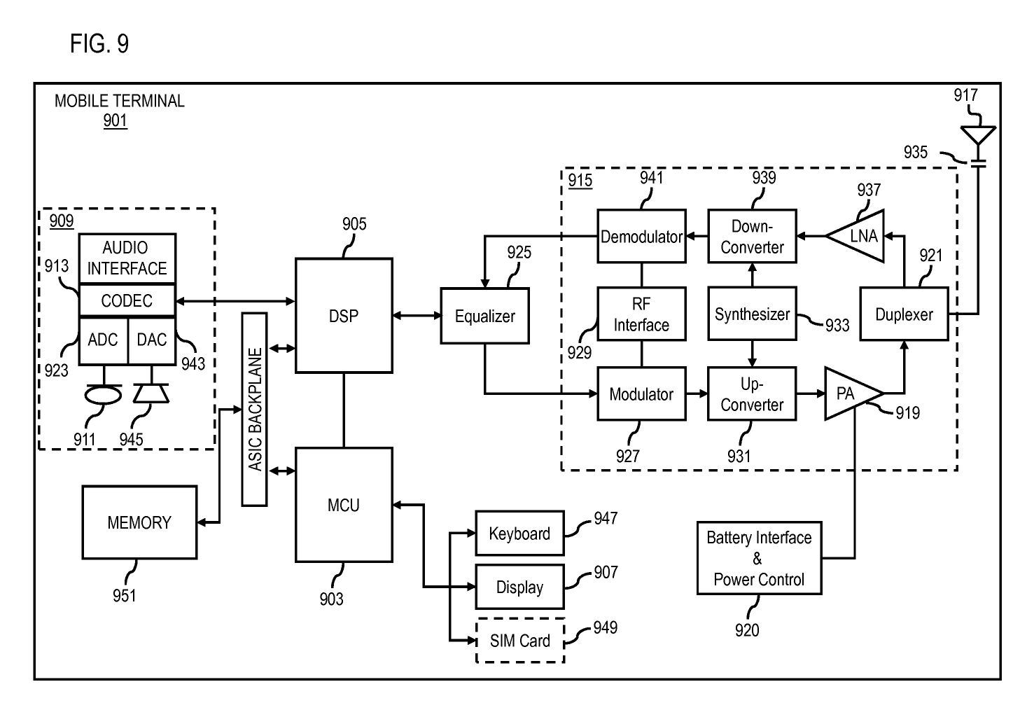

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of receiving content based on a pub/sub storage system. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of receiving content based on a pub/sub storage system. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to receive content based on a pub/sub storage system. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining to publish a request for content, the request based, at least in part, on one or more criteria;
receiving one or more responses from one or more storage blocks that have one or more subscriptions to at least one of the one or more criteria; and
determining to publish another request to transfer the content to at least one destination subscription based, at least in part, on the one or more responses.

2. A method of claim 1, further comprising:
determining the one or more storage blocks from a routing table,
wherein the routing table maps one or more subscriptions of the one or more storage blocks to the one or more criteria.

3. A method of claim 1, further comprising:
determining that the content is available from more than one of the one or more storage blocks,
wherein the another request is further based, at least in part, on the availability of the content from the more than one of the one or more storage blocks.

4. A method of claim 1, further comprising:
determining that there is an update to the content; and
determining to update at least one of the one or more storage blocks based, at least in part, on the one or more subscriptions.

5. A method of claim 1, further comprising:
determining one or more versions of the content;
determining respective frequencies of access to the one or more versions; and
determining to archive the one or more versions based, at least in part, on the respective frequencies of access.

6. A method of claim 1, wherein the one or more responses are published by the one or more storage blocks and include, at least in part, information regarding structure, availability, or a combination thereof.

7. A method of claim 1, wherein transfer of the content is by a unicast or a multicast from at least one of the one or more storage blocks.

8. A method of claim 1, wherein the one or more criteria include an address range, a content request type, a probabilistic analysis, or a combination thereof.

9. An apparatus comprising:
at least one processor; and
at least one memory including computer program code for one or more programs,
the at least one memory and the computer program code configured to, with the at least one processor, cause the apparatus to perform at least the following,
determine to publish a request for content, the request based, at least in part, on one or more criteria;
receive one or more responses from one or more storage blocks that have one or more subscriptions to at least one of the one or more criteria; and
determine to publish another request to transfer the content to at least one destination subscription based, at least in part, on the one or more responses.

10. An apparatus of claim 9, wherein the apparatus is further caused to:
determine the one or more storage blocks from a routing table,
wherein the routing table maps one or more subscriptions of the one or more storage blocks to the one or more criteria.

11. An apparatus of claim 9, wherein the apparatus is further caused to:
determine that the content is available from more than one of the one or more storage blocks,
wherein the another request is further based, at least in part, on the availability of the content from the more than one of the one or more storage blocks.

12. An apparatus of claim 9, wherein the apparatus is further caused to:
determine that there is an update to the content; and
determine to update at least one of the one or more storage blocks based, at least in part, on the one or more subscriptions.

13. An apparatus of claim 9, wherein the apparatus is further caused to:
determine one or more versions of the content;
determine respective frequencies of access to the one or more versions; and
determine to archive the one or more versions based, at least in part, on the respective frequencies of access.

14. An apparatus of claim 9, wherein the one or more responses are published by the one or more storage blocks and include, at least in part, information regarding structure, availability, or a combination thereof.

15. An apparatus of claim 9, wherein transfer of the content is by a unicast or a multicast from at least one of the one or more storage blocks.

16. An apparatus of claim 9, wherein the one or more criteria include an address range, a content request type, a probabilistic analysis, or a combination thereof.

17. A computer-readable storage medium carrying one or more sequences of one or more instructions which, when executed by one or more processors, cause an apparatus to at least perform the following steps:
determining to publish a request for content, the request based, at least in part, on one or more criteria;
receiving one or more responses from one or more storage blocks that have one or more subscriptions to at least one of the one or more criteria; and
determining to publish another request to transfer the content to at least one destination subscription based, at least in part, on the one or more responses.

18. A computer-readable storage medium of claim 17, wherein the apparatus is caused to further perform:
determining the one or more storage blocks from a routing table,
wherein the routing table maps one or more subscriptions of the one or more storage blocks to the one or more criteria.

19. A computer-readable storage medium of claim 17, wherein the apparatus is caused to further perform:
determining that the content is available from more than one of the one or more storage blocks,
wherein the another request is further based, at least in part, on the availability of the content from the more than one of the one or more storage blocks.

20. A computer-readable storage medium of claim 17, wherein the apparatus is caused to further perform:
determining that there is an update to the content; and
determining to update at least one of the one or more storage blocks based, at least in part, on the one or more subscriptions.

21.-42. (canceled)
